(19) United States
(12) Patent Application Publication
(10) Pub. No.: US 2025/0237913 A1
(43) Pub. Date: Jul. 24, 2025

(54) SYSTEMS AND METHODS FOR LOW OPTICAL INTENSITY OPTICALLY ADDRESSABLE LIGHT VALVES

(71) Applicant: Lawrence Livermore National Security, LLC, Livermore, CA (US)

(72) Inventors: Lars F. VOSS, Fremont, CA (US); Qinghui Shao, Fremont, CA (US); Clint D. Frye, Oakland, CA (US)

(21) Appl. No.: 18/957,024

(22) Filed: Nov. 22, 2024

Related U.S. Application Data
(60) Provisional application No. 63/623,882, filed on Jan. 23, 2024.

(51) Int. Cl. G02F 1/135; G02F 1/1335

(52) U.S. Cl. CPC G02F 1/1354; G02F 1/133502; G02F 1/133528

(57) ABSTRACT

An optically addressable light valve (OALV) is disclosed which has a liquid crystal having an input side and an output side. The OALV also has a photoconductor having an input side and an output side, and a dopant providing increased damage tolerance for the photoconductor. A polarizer is also provided which is arranged downstream of the liquid crystal, relative to a travel of light through the OALV. A conductive material is also provided which is applied to the input side of the photoconductor.

### CROSS-REFERENCE TO RELATED APPLICATIONS

This application claims the benefit of U.S. Provisional Application No. 63/623,882, filed on Jan. 23, 2024. The disclosure of the above application is incorporated herein by reference.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to light valves, and more particularly to an optically addressable light valve having significantly increased damage tolerance.

### BACKGROUND

The statements in this section merely provide background information related to the present disclosure and may not constitute prior art.

Optically addressable light valves (“OALVs”) are presently in common use for controlling the spatial shape of laser beams, when the laser beams are employed in various manufacturing systems. While a multitude of elements are present in an OALV, the key elements are a transparent conductor (e.g., typically a conductive film), a photoconductor (frequently Sillenite photorefractive crystals such as Bismuth Silicon Oxide (BSO) or Bismuth Germanium Oxide (BGO)), and a liquid crystal. The OALV is operated by applying a voltage from the transparent conductor, across the photoconductor, and then terminating on the other end of the liquid crystal. FIG. 1 shows a high level, simplified side view of the typical components of an OALV.

Referring further to FIG. 1, the conductivity of the photoconductor is controlled with a first wavelength of light, which generates charge carriers within the material. This light may be spatially patterned, for example using a digital light projection system. Where the photoconductor becomes conductive, the voltage dropped across it decreases and correspondingly increases across the liquid crystal. This actuates the liquid crystal. At the same time, the laser or other light source to be spatially shaped is incident on the OALV. In the locations where the liquid crystal's orientation has changed, it acts to keep the polarization of the laser beam. The laser beam then passes through a polarizer, which allows only light with the correct polarization to pass through. OALVs can thus be used to control the spatial shape of a laser beam in real time. They are currently used in the National Ignition Facility (“NIF”) operated by Lawrence Livermore National Laboratory. The OALV provides programmable spatial shaping system to protect the NIF optics. They are also used in diode based additive manufacturing to 3D print metal shapes.

### SUMMARY

This section provides a general summary of the disclosure, and is not a comprehensive disclosure of its full scope or all of its features.

In one aspect the present disclosure relates to an optically addressable light valve (OALV). The OALV may comprise a liquid crystal having an input side and an output side, and a photoconductor. The photoconductor has an input side and an output side, and further includes a dopant providing increased damage tolerance to the photoconductor. A polarizer is arranged downstream of the liquid crystal, relative to a travel of light through the OALV, and a conductive material applied to the input side of the photoconductor.

In another aspect the present disclosure relates to an optically addressable light valve (OALV). The OALV may comprise a liquid crystal having an input side and an output side, and a photoconductor. The photoconductor may have an input side and an output side, and further has a dopant including at least one of manganese (Mn), iron (Fe) and carbon (C) for providing increased damage tolerance to the photoconductor. A dichroic antireflection coating is included which is applied to at least one of the output side of the photoconductor or the input side of the liquid crystal. A polarizer is arranged downstream of the liquid crystal, relative to a travel of light through the OALV, and a conductive material is applied to the input side of the photoconductor.

In still another aspect the present disclosure relates to a method for forming an optically addressable light valve (OALV). The method may comprise providing a liquid crystal having an input side and an output side. The method may further include doping a photoconductor having an input side and an output side with a dopant providing increased damage tolerance to the photoconductor. The method may further include arranging a polarizer downstream of the liquid crystal, relative to a travel of light through the OALV, and placing a conductive material to the input side of the photoconductor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level side cross sectional view of a prior art liquid crystal display system with a polarizer;

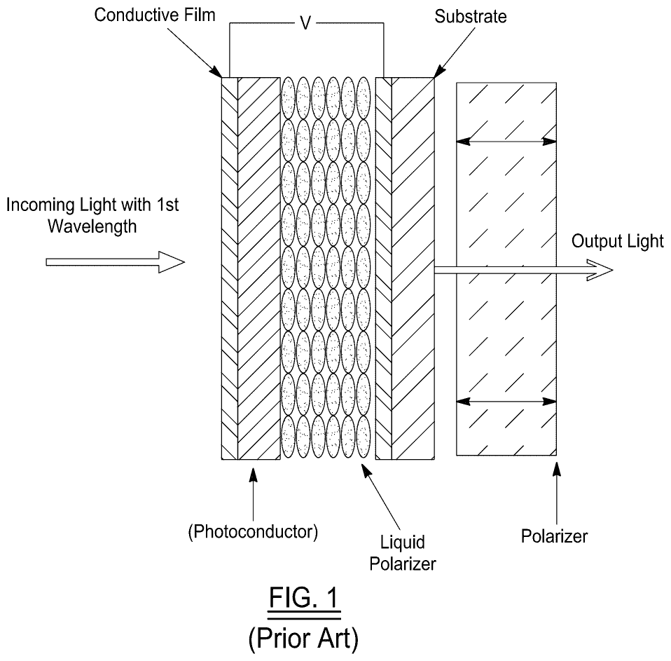

FIG. 2 is a high level, highly simplified side cross-sectional view of a liquid crystal display system in accordance with one embodiment of the present disclosure; and

FIG. 3 is a high level flowchart of various operations that may be performed in manufacturing the OALV of FIG. 2.

### DETAILED DESCRIPTION

Example embodiments will now be described more fully with reference to the accompanying drawings.

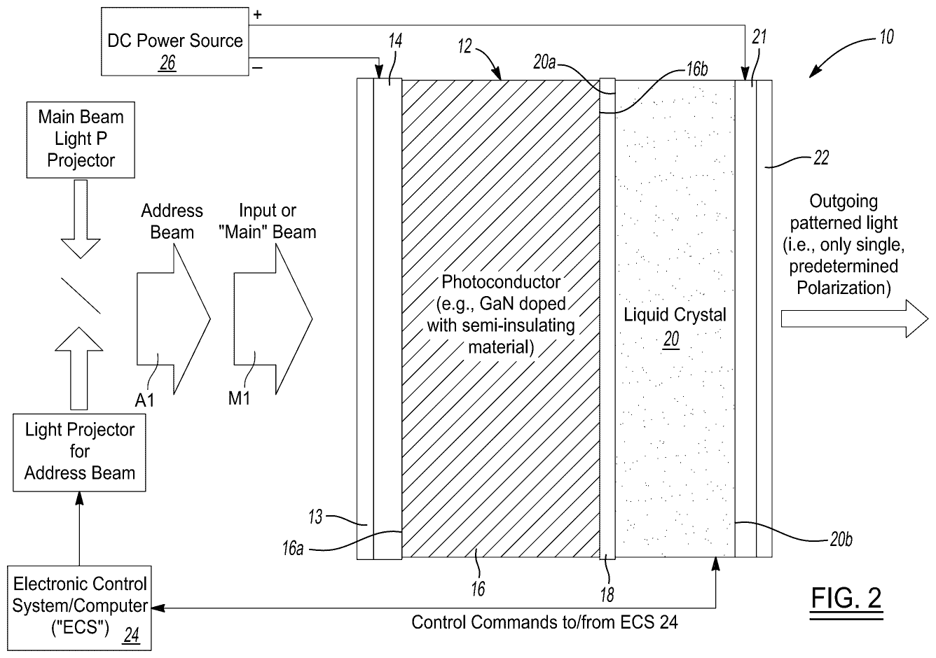

Referring to FIG. 2, there is shown one embodiment of a OALV system 10 in accordance with the present disclosure. A OALV device component 12 is provided which in this example includes a first polarizer 13, a conductive film 14, a photoconductor 16 with high damage tolerance, doped with a dopant to make it semi-insulating, a dichroic anti-reflection coating 18, a liquid crystal 20, a transparent conductor 21 (e.g., ITO (Indium Tin Oxide), N or P-type GaN, and a second polarizer 22. The polarization direction of the first polarizer 13 is parallel to the polarization direction of the second polarizer 22. The system 10 further may include an electronic control system/computer (“ECS”) 24 for digitally controlling the liquid crystal. A DC power supply 26 may be used to supply a potential difference across the liquid crystal component 12

Both an address beam A1 and a main beam M1 are projected into an input side 16a of the photoconductor 16. The main beam M1 passes fully through the photoconductor 16 and exits an output side 16b, whereafter it enters an input side 20a of the liquid crystal 20. The main beam M1 passes fully through the liquid crystal 20 and the transparent conductor 21 and emerges from an output side 20b, typically with the polarization of spatial portions thereof having been modified by the liquid crystal 20 in accordance with a predetermined spatial pattern provided by the address beam A1. The main beam M1 will then impinge the second polarizer 22, and only those portions of the main beam which have a polarization which matches the second polarizer will pass through the second polarizer. The address beam A1 will be reflected back into an input side 16a of the photoconductor 16 after impinging the dichroic antireflection coating 18.

The photoconductor 16 may be formed from any suitable material, but in some embodiments is formed from a semiconductor which is doped with the semi-insulating dopant. The dichroic antireflection coating 18 between the photoconductor 16 and liquid crystal 20 interface enables transmitting the main beam M1 therethrough, while enabling a reflection of the address beam A1.

An important feature of the OALV device 12 is the construction of the photoconductor 16. The photoconductor 16 is constructed of a semi-insulating gallium nitride (GaN) enhanced with other dopants to provide a high damage tolerant photoconductor with a high photo-responsivity. In some embodiments the dopant may be manganese (Mn). In some embodiments the dopant may be carbon (C). In some embodiments the dopant may be iron (Fe). In some embodiments two or more of the above dopants may be used in preselected concentrations. The above-mentioned dopants are not intended to be a limiting list, and it will be understood that in some applications other dopants besides those mentioned herein may be used as well, either alone or in combination with one or more of the above-mentioned dopants. Various factors may play a part in selecting one or more specific dopants to use; however, a central important factor is that the selected dopant(s) need to be effective compensators to make the GaN semi-insulating and possess the merit of high photo-responsivity. With specific regard to “semi-insulating”, it will be understood that the use of this terminology is intended to mean a resistivity of at least about 1×10⁶ ohm-centimeter; or put differently, that the total resistance of the photoconductor 16 should be greater than the resistance of the liquid crystal 20.

The quantity of dopant with compensating function needs to be sufficient so that the photoconductor is resistive enough under a dark condition. The quantity of dopant with light absorption function needs to be sufficient so that it is responsive to the address beam A1. The quantity cannot be high enough to compromise the photoconductor crystal integrity or damage tolerance. In some embodiments the dopant may be in the range of 1×10¹⁶ to about 1×10²⁰ cm⁻³.

In some embodiments each of the Mn, C and Fe dopants mixed in with the GaN material of the photoconductor 16 may be in the range of 1×10¹⁶ to 1×10²⁰ cm⁻³ as stated above.

In some embodiments the precise dopant(s) (e.g., Mn, C and/or Fe may be selected based on one or more external factors (e.g., laser wavelength). The energy levels formed by Mn, C or Fe in the GaN of the photoconductor 16 should be deep enough to allow transmission of the main beam M1 and yet shallow enough to allow good absorption of the address beam A1. The specific dopant(s) selected will also be dependent on the specific use of the OALV device 12 and what wavelength it is meant to pattern.

The dopants (e.g., Mn, C, or Fe) effectively provide a highly damage tolerant photoconductor with high responsivity to various pump wavelength light. The dopant provides a source of electrons or holes that can be excited. This, when combined with the use of the dichroic antireflection coating 18 at the photoconductor/liquid crystal 16/GaN/polyimide/liquid crystal interface that has low reflectivity/high transmissivity for the main beam to be patterned, but high reflectivity for the address or pump beam. This enables a ‘double pass’ of light through the photoconductor 16. The thickness of the photoconductor 16 is additionally chosen to maximize responsivity such that the photoconductor is uniformly illuminated by the double pass beam. In some embodiments the photoconductor 16 may be, without limitation, between about 25 μm-1000 μm. In some embodiments the photoconductor 16 may be, without limitation, between about 50 μm-500 μm thick. Preferably, the thickness of the photoconductor 16 is well matched to be in the order of the address the beam A1 absorption depth. In some embodiments this depth may be 0.1-10 absorption depths. But the selected thickness still should be sufficiently thick to enable functionality.

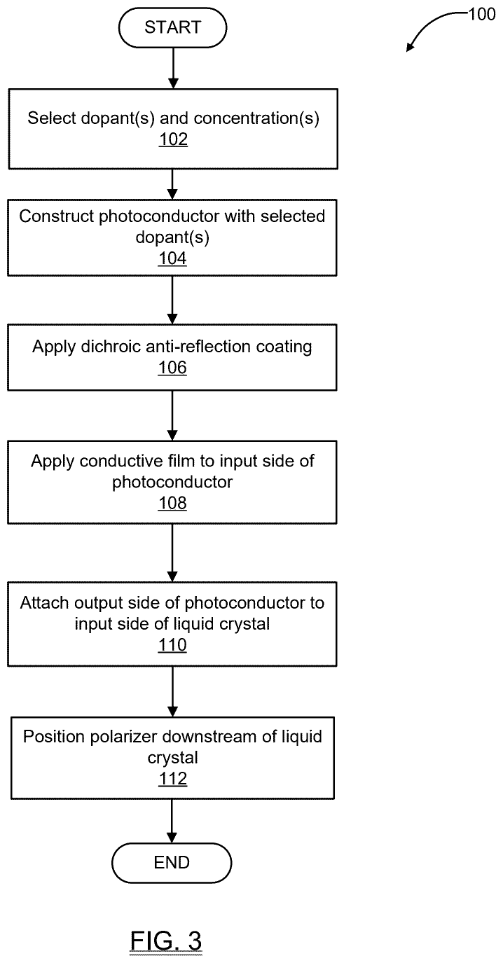

Referring briefly to FIG. 3, there is a flowchart 100 showing one example of various operations that may be performed in forming the OALV of FIG. 2. It is possible that the order of operations shown in FIG. 3 may be varied, and that additional operations not described may be performed at intermediate points of the construction process. In this example, however, at operation 102 one or more dopants are initially selected for manufacturing the photoconductor 16. The photoconductor 16 is then constructed with the selected dopant(s) as indicated at operation 104. At operation 106 the dichroic anti-reflection coating 18 may be applied (e.g., to at least one of the output side 16a of the photoconductor 16 or the input side 20a of the liquid crystal 20). At operation 108 the conductive film 14 may be applied to the input side 16a of the photoconductor 16. At operation 110 the output side 16b of the photoconductor 16 may be attached to the input side 20a of the liquid crystal 20. At operation 112 the polarizer 22 may be positioned downstream of the liquid crystal 16.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An optically addressable light valve (OALV) comprising:
a liquid crystal having an input side and an output side;
a photoconductor having an input side and an output side, and further having a dopant providing increased damage tolerance to the photoconductor;
a first polarizer arranged adjacent to the input side of the photoconductor;
a second polarizer arranged downstream of the liquid crystal, relative to a travel of light through the OALV; and
a conductive material applied to the input side of the photoconductor.

2. The OALV of claim 1, further comprising a dichroic antireflection coating applied to at least one of the output side of the photoconductor or the input side of the liquid crystal.

3. The OALV of claim 1, wherein the dopant comprises manganese (Mn).

4. The OALV of claim 3, wherein the photoconductor comprises gallium nitride (GaN).

5. The OALV of claim 4, wherein the manganese comprises between 1×10¹⁶-1×10²⁰ cm⁻³ of a total amount of material used to construct the photoconductor.

6. The OALV of claim 1, wherein the dopant comprises iron (Fe).

7. The OALV of claim 6, wherein the photoconductor comprises gallium nitride.

8. The OALV of claim 7, wherein the iron comprises between 1×10¹⁶-1×10²⁰ cm⁻³ of a total amount of material used to construct the photoconductor.

9. The OALV of claim 1, wherein the dopant comprises carbon (C).

10. The OALV of claim 9, wherein the photoconductor comprises gallium nitride.

11. The OALV of claim 10, wherein the carbon comprises between 1×10¹⁶-1×10²⁰ cm⁻³ of a total amount of material used to construct the photoconductor.

12. The OALV of claim 1, wherein the dopant comprises a combination of two or more of:
manganese;
iron; and
carbon.

13. The OALV of claim 1, further comprising an electronic control system/computer for controlling generation of an address beam to control polarization of the liquid crystal.

14. The OALV of claim 1, further comprising a DC power source for applying a DC potential across the OALV.

15. An optically addressable light valve (OALV) comprising:
a liquid crystal having an input side and an output side;
a photoconductor having an input side and an output side, and further having a dopant including at least one of manganese (Mn), iron (Fe) and carbon (C) for providing increased damage tolerance to the photoconductor;
a first polarizer arranged adjacent to the input side of the photoconductor;
a dichroic antireflection coating applied to at least one of the output side of the photoconductor or the input side of the liquid crystal;
a polarizer arranged downstream of the liquid crystal, relative to a travel of light through the OALV; and
a conductive material applied to the input side of the photoconductor.

16. The optically addressable light valve of claim 14, wherein the photoconductor comprises gallium nitride (GaN) having the dopant.

17. The OALV of claim 15, wherein the dopant comprises two or more of manganese, iron and carbon.

18. A method for forming an optically addressable light valve (OALV) comprising:
providing a liquid crystal having an input side and an output side;
doping a photoconductor having an input side and an output side with a dopant providing increased damage tolerance to the photoconductor;
arranging a polarizer adjacent to the input side of the photoconductor;
arranging a polarizer downstream of the liquid crystal, relative to a travel of light through the OALV; and
placing a conductive material to the input side of the photoconductor.

19. The method of claim 18 further comprising applying a dichroic antireflection coating to at least one of the output side of the photoconductor or the input side of the liquid crystal.
